(19) United States
(12) Patent Application Publication
(10) Pub. No.: US 2019/0135565 A1
(43) Pub. Date: May 9, 2019

(54) RECORDING MEDIUM CONVEYANCE DEVICE AND INKJET RECORDING DEVICE

(71) Applicant: Konica Minolta, Inc., Tokyo (JP)

(72) Inventor: Mitsuo KABURAGI, Hachioji-shi, Tokyo (JP)

(21) Appl. No.: 16/097,867

(22) PCT Filed: May 9, 2017
(86) PCT No.: PCT/JP2017/017547

§ 371 Date: Oct. 31, 2018

(30) Foreign Application Priority Data
May 27, 2016 (JP) 2016-106279

(51) Int. Cl. B65H 5/08; B65H 5/22; B65H 5/36; B41J 2/04

(52) U.S. Cl. CPC B65H 5/085; B41J 2/04; B65H 5/36; B65H 5/224

(57) ABSTRACT

A recording medium conveyance device of an inkjet recording device includes a belt-form member, two conveyance rollers, a driver, a supporting board, a suction unit, and a guide roller. The recording medium is placed on the outer circumferential surface of the belt-form member. The belt-form member is pulled over the two conveyance rollers which cause the belt-form member to circulate. The driver causes at least one of the two conveyance rollers to rotate. The supporting board supports the inner circumferential surface of the belt-form member on a plane. The suction unit pulls the recording medium placed on the belt-form member to the outer circumferential surface of the belt-form member. The guide roller is arranged between at least one of the two conveyance rollers and the supporting board and supports the inner circumferential surface of the belt-form member.

### TECHNOLOGICAL FIELD

The present invention relates to a recording medium conveyance device and an inkjet recording device.

### BACKGROUND ART

Conventionally, there have been inkjet recording devices which eject ink drops onto a recording medium to record images on the recording medium. In the inkjet recording devices, two-dimensional images are recorded on a recording medium by relative movement of inkjet heads ejecting ink drops and the recording medium. To record images on a lot of recording media, an inkjet recording device is generally configured at least to be able to convey recording media to discharge the recording media to a medium discharge unit after images are recorded on the recording media supplied from the medium supply unit.

As the accuracy improves in images to be recorded by inkjet recording devices, the conveyance by the conveyor conveying recording media is required to have high accuracy. Disclosed in the patent document 1 is a technique to maintain the planeness of a recording medium which is placed on and pulled to an endless belt by appropriately keeping the planeness of a supporting board (guide board) supporting the endless belt at the part facing the inkjet heads of the endless belt rolled onto the roller.

### PRIOR ART DOCUMENTS

### Patent Documents

Patent Document 1: Japanese Patent Application Laid Open Publication No. 2004-210530

### SUMMARY OF THE INVENTION

### Problems to be Solved by the Invention

However, as the effects such as shaking of the endless belt or the whole conveyor cannot be appropriately taken away just with the supporting board supporting the conveyance member, the positional accuracy of recording media may be lowered by those effects.

An object of the present invention is to provide a recording medium conveyance device and an inkjet recording device which can convey recording media with a higher positional accuracy.

### Means for Solving the Problems

In order to achieve the above object, the invention according to claim 1 is a recording medium conveyance device of an inkjet recording device to record image with a recording head ejecting ink onto a recording medium, the recording medium conveyance device including:

an endless belt-form member on an outer circumferential surface of which the recording medium is placed;

two conveyance rollers over which the belt-form member is pulled and which cause the belt-form member to circulate according to a rotation movement;

a driver which causes at least one of the two conveyance rollers to rotate;

a supporting board which supports an inner circumferential surface of the belt-form member on a plane in one section where the outer circumferential surface faces an ink ejection face of the recording head, the one section being one of sections of the belt-form member divided by the two conveyance rollers;

a suction unit which sucks air from a side of the outer circumferential surface of the belt-form member through a pore of the belt-form member and a pore of the supporting board to pull the recording medium placed on the belt-form member to the outer circumferential surface of the belt-form member; and

a guide roller which is arranged between at least one of the two conveyance rollers and the supporting board and which supports the inner circumferential surface of the belt-form member;

wherein the guide roller is arranged such that the belt-form member moves on a plane same as the supporting board between the guide roller and the supporting board.

The invention according to claim 2 is the recording medium conveyance device according to claim 1, wherein the at least one of the conveyance rollers is arranged such that the belt-form member moves in a direction crossing the plane at a predetermined angle between the at least one of the conveyance rollers and the guide roller which is arranged between the at least one of the conveyance rollers and the supporting board.

The invention according to claim 3 is the recording medium conveyance device according to claim 2, wherein the recording medium is placed on the belt-form member in a section where the belt-form member moves on the plane.

The invention according to claim 4 is the recording medium conveyance device according to any one of claims 1 to 3, wherein the supporting board is formed using a porous material.

The invention according to claim 5 is the recording medium conveyance device according to any one of claims 1 to 4, wherein the belt-form member is a steel belt.

The invention according to claim 6 is the recording medium conveyance device according to any one of claims 1 to 5, wherein a rotation radius of the guide roller is smaller than a rotation radius of the at least one of the conveyance rollers.

The invention according to claim 7 is the recording medium conveyance device according to any one of claims 1 to 6, wherein a floating suppresser which leads the recording medium placed on the belt-form member along the surface of the belt-form member is arranged on an upstream side from the supporting board in a direction of conveyance of the recording medium by the belt-form member.

The invention according to claim 8 is the recording medium conveyance device according to claim 7,

wherein the guide roller is arranged at least on the upstream side from the supporting board in the direction of conveyance of the recording medium,

wherein the floating suppressor is arranged at a position facing the guide roller with the belt-form member in between.

The invention according to claim 9 is the recording medium conveyance device according to claim 7,

wherein the guide roller is arranged between the supporting board and each of the two conveyance rollers, and

wherein the floating suppressor is each arranged at a position facing the guide roller with the belt-form member in between.

The invention according to claim 10 is the recording medium conveyance device according to any one of claims 1 to 9 including a tension adjuster which adds tension equally to the belt-form member at positions different in a width direction perpendicular to a movement direction of the circling conveyance belt, in a section opposite to the one section of the sections of the belt-form member divided by the two conveyance rollers.

The invention according to claim 11 is the recording medium conveyance device according to any one of claims 1 to 10 including a heater which heats the recording medium on the upstream side from the supporting board in a direction of conveyance of the recording medium by the belt-form member.

The invention according to claim 12 is the recording medium conveyance device according to claim 11, wherein the heater heats the recording medium via the belt-form member by heating the belt-form member.

The invention according to claim 13 is the recording medium conveyance device according to claim 11, wherein the heater has a heat source inside at least one roller member touching at least one of the belt-form member and the recording medium.

The invention according to claim 14 is the inkjet recording device including a recording medium conveyance device according to any one of claims 1 to 13, and the recording head ejecting ink onto the recording medium conveyed by the recording medium conveyance device.

### Effects of the Invention

The present invention has an effect of conveying recording media with a higher positional accuracy in a recording medium conveyance device of an inkjet recording device.

### BRIEF DESCRIPTION OF THE DRAWINGS

FIG. 1 shows a schematic configuration of an inkjet recording device including a recording medium conveyance device in accordance with an embodiment of the present invention.

FIG. 2 shows an enlarged drawing of a configuration of a conveyor at the back and front of a guide roller.

FIG. 3 shows an exemplary structure of a driven roller.

FIG. 4A shows a modification example 1 of the conveyor.

FIG. 4B shows a modification example 2 of the conveyor.

### EMBODIMENTS FOR CARRYING OUT THE INVENTION

Hereinafter an embodiment of the present invention is described with reference to the drawings.

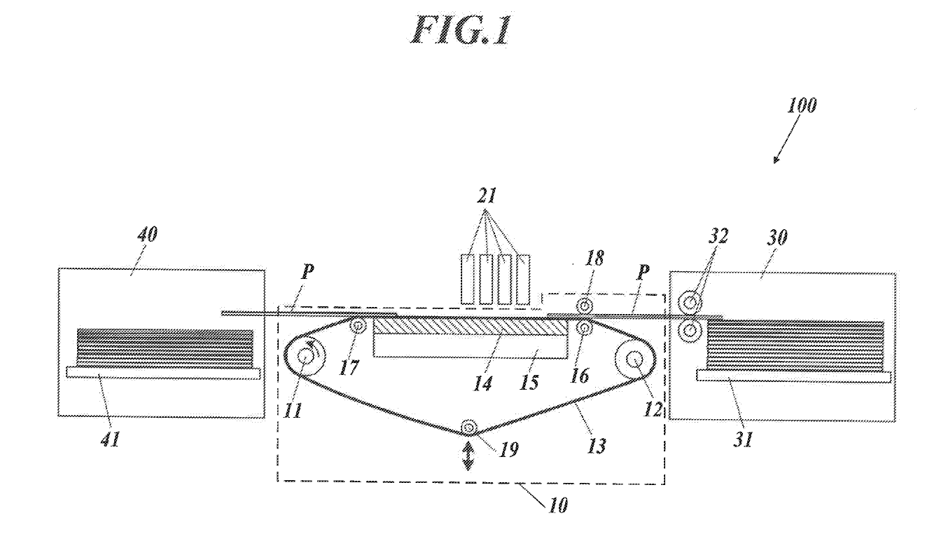

FIG. 1 shows a whole configuration of an inkjet recording device 100 including a conveyor 10 which is the recording medium conveyance device in the present embodiment.

The inkjet recording device 100 includes a medium supply unit 30, a conveyor 10, an image recorder 20, and a medium discharge unit 40, etc.

The medium supply unit 30 includes a placement tray 31, a medium output unit 32, etc.

The placement tray 31 is a board-shaped member on which individual recording media P such as one or more pieces of paper may be placed, and recording media P are sent to the conveyor 10 one by one from the top. The placement tray 31 can move up and down, and the recording medium P at the top is retained at the sending position to the conveyor 10 according to the entire weight of the placed recording media P. The type of the recording media P is not specifically limited, and cardboard paper is used in this embodiment, for example. The varying degree of the height of the placement tray 31 may be adjustable depending on the type of the recording media P according to the setting.

The medium output unit 32 includes rotatable rollers, for example, which hold the medium to be sent out from top and bottom, and sends out the recording medium P in the horizontal direction in this embodiment. The medium output unit 32 may further include an endless sending belt on which the recording medium P is put to be sent out at the height of the upper surface (the supporting face) of a supporting board 14 to the vicinity of a guide roller 16, and include two rollers over which the sending belt is pulled.

The conveyor 10 conveys and sends out the recording medium P received from the medium supply unit 30 to the medium discharge unit 40. The conveyor 10 includes a driven roller 11, a passive roller 12, a conveyance belt 13 (belt-shaped member), a supporting board 14 (platen), a suction unit 15, guide rollers 16 and 17, a pressing roller 18 (floating suppresser), a tension roller 19 (tension adjuster), etc.

The conveyance belt 13 is an endless belt, and a steal belt is used in this embodiment. The material is, for example, SUS304, SUS631, alloyed aluminum, etc. The conveyance belt 13 extends between the driven roller 11 and the passive roller 12 (also referred to as two conveyance rollers 11 and 12 together), and circles according to the rotation speed and the rotating direction of the driven roller 11 as the driven roller 11 rotates with the rotation of the conveyance motor. In this embodiment, the conveyance belt 13 moves in the usual conveyance direction of the recording medium P as the driven roller 11 rotates counter-clockwise in the section shown in FIG. 1. The recording medium P sent out from the medium supply unit 30 is placed on the outer circumferential surface of the conveyance belt 13 (that is, the face not touching the conveyance rollers 11 and 12), and is conveyed with the movement of the conveyance belt 13.

In one of the sections of the conveyance belt 13 divided by the two conveyance rollers 11 and 12, the recording medium P to be conveyed, that is, the outer circumferential surface of the conveyance belt 13, faces the head units 21 (the ink ejection side of the recording heads). The supporting board 14 supports, on a plane (the horizontal plane here), the inner circumferential surface (the face touching the conveyance rollers 11 and 12) of the conveyance belt 13 in the range including the part where the recording unit faces the head units 21. The upper surface of the supporting board 14 (the supporting face) forming this plane is arranged in the horizontal direction at the position higher than the line connecting the upper edges of the driven roller 11 and the passive roller 12. The conveyance belt 13 supported by the supporting board 14 causes the recording medium P sent out from the medium supply unit 30 in the horizontal direction to move on the supporting board 14 while the recording medium P is being placed on the conveyance belt 13 with its position unchanged in the vertical direction.

The supporting board 14 longer in the conveyance direction may stabilize the recording medium P more in the image recording by the image recorder 20, but the area occupied in the horizontal direction increases. Thus, the length of the supporting board 14 is suitably determined according to the approximate length of the recording media P in the conveyance direction, for example (if the recording media are in a single size, on the basis of that single size, and if the image recording is possible for recording media P in multiple sizes, on the basis of the regular length or the maximum length).

The conveyance belt 13 and the supporting board 14 have a lot of pores through which air can pass. Various known porous materials whose upper surface is processed to be plane are used for the supporting board 14 in this embodiment. The size, number, and positioning of the pores of the conveyance belt 13 are defined in the range where the recording media P can be placed consistently.

The suction unit 15 is arranged in the lower side of the supporting board 14, that is, on the opposite of the side touching the conveyance belt 13, and pulls the recording medium P placed on the outer circumferential surface of the conveyance belt 13 to the conveyance belt 13 by sucking air from the outer circumferential surface side of the conveyance belt 13 through the pores of the conveyance belt 13 and the supporting board 14.

The guide roller 16 is arranged on the upstream side of the supporting board 14 in the moving direction of the conveyance belt 13 (the conveyance direction of the recording media P), and the guide roller 17 is arranged on the downstream side of the supporting board 14. The guide rollers 16 and 17 support the conveyance belt 13 at the outer side of both edges of the supporting face.

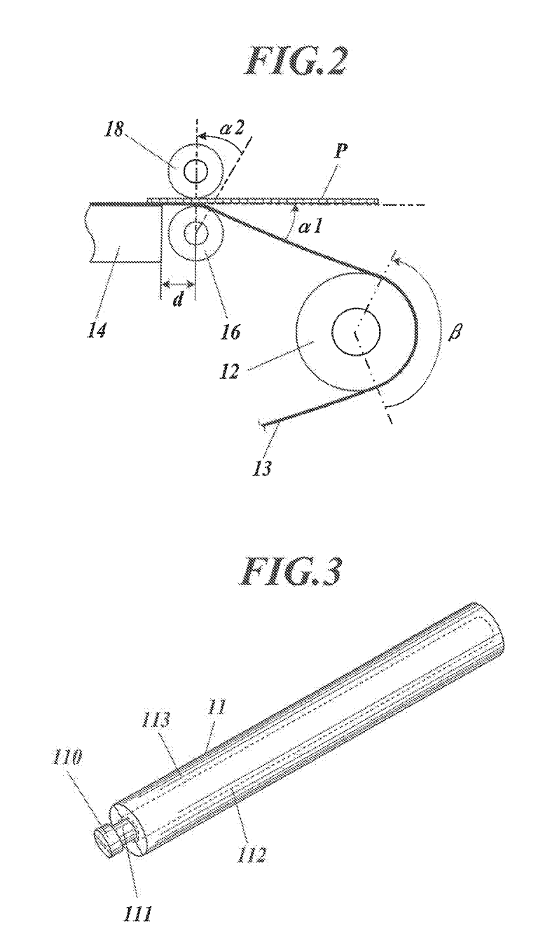

FIG. 2 is an enlarged drawing of a configuration of the conveyor 10 at the back and front of the guide roller 16.

The guide rollers 16 and 17 each support the conveyance belt 13 at the same height as the supporting face of the supporting board 14. That is, the conveyance belt 13 moves from the position touching the passive roller 12 to the position touching the guide roller 16 in a direction including a vertically upward component, and turns to the horizontal direction to move to the position touching the supporting face of the supporting board 14. The conveyance belt 13 moving from the position touching the supporting face of the supporting board 14 continuously moves in the horizontal direction to the position touching the guide roller 17, and then moves to the position touching the driven roller 11 in a direction including a vertically downward component.

The same height (being on the same plane) described in this embodiment does not require strict equality. It is generally allowable to deviate at a visible level, by less than 1 to 2 cm or 1 to 2 degrees in angle, for example, as long as the recording medium P does not hit the conveyance belt 13 when being placed onto the conveyance belt 13 because the position of the guide roller 16 is high, or the recording medium P is not bent when being pressed down by the pressing roller 18 due to too large deviation, that is, as long as the deviation is not too large for the hardness or size (including thickness of the recording medium P).

The guide rollers 16 and 17 have smaller rotation radii than the driven roller 11 and the passive roller 12, and the top of the guide rollers 16 and 17 and the respective edges of the supporting board 14 may be arranged nearby (distance d smaller) in a simple structure. As a result, the reduction in occurrence of shaking (mainly transverse wave in the vertical direction) of the conveyance belt 13 between the top of the guide rollers 16 and 17 and the supporting board 14 and spreading of the shaking to the surrounding parts such as the supporting board 14 which is easily caused especially in a steel belt may restrain the deterioration of the recorded images due to the positional deviation of the recording medium P.

The driven roller 11 and the passive roller 12 are preferably arranged so that the angle α1 (crossing angle) between the supporting face of the supporting board 14 and the conveyance belt 13 from the position abutting the passive roller 12 to the position abutting the guide roller 16 and the angle between the supporting face of the supporting board 14 and the conveyance belt 13 from the position abutting the guide roller 17 to the position abutting the passive roller 11, that is, the angle ranges of the conveyance belt 13 abutting respectively the guide rollers 16 and 17 (wrapping angle α2), are not so broad. In that way, the bending angles of the conveyance belt 13 at the front and back of the section of the conveyance belt 13 where supported by the supporting board 14 are kept small. The wrapping angle α2 is, for example, equal to or smaller than 90 degrees, preferably equal to or smaller than 30 degrees. As the wrapping angle α2 is larger, the friction between the conveyance belt 13 and the guide rollers 16 and 17 is larger, shaking of the conveyance belt 13 is more likely to occur and causes abnormality in the conveyance of the recording media P. As described above, the movement accuracy and positional accuracy of the recording medium P may be improved, as the conveyance belt 13 moves almost on a single plane in the range where the recording medium P is conveyed and the head units 21 perform the image recording.

The pressing roller 18 is arranged at the position facing the guide roller 16 across the conveyance belt 13, and leads the recording medium P along the conveyance belt 13 by pressing the recording medium P sent out from the medium supply unit 30 to the conveyance belt 13 at an appropriate pressure so that the recording medium P does not float up from the guide roller 16 and the supporting board 14. The recording medium P often has a curl (curling up) on its tip since being supplied. Especially, when the recording medium P is heated according to the appropriate temperature of landing ink to be supplied to the conveyor 10, a curl (curling up) on the recording medium P could be caused by the heating. Thus, the pressing by the pressing roller 18 prevents the recording medium P from curling and from floating up from the outer circumferential surface of the conveyance belt 13 at the arrival onto the supporting face, so that the recording medium P is pulled to the conveyance belt 13 swiftly and certainly.

The position of the pressing roller 18 (the distance from the guide roller 16) may be adjustable up and down according to the thickness of the recording medium P. A driver to vary the position of the pressing roller 18 such as a motor and a motor driver, for example, may be included, and the controller such as a CPU may maintain the state where the appropriate pressure is put on the recording medium P by controlling the driver to adjust the position of the pressing roller 18 up and down. By that positional control, the recording medium P may be lead more stably to between the pressing roller 18 and the guide roller 16. The thickness of the recording medium P may be detected by a known sensor, etc. or determined on the basis of the input operation by the user to an operation receiving unit such as a touch panel, or the setting data included in the print job.

The recording medium P may be heated by the heated pressing roller 18, or by the heated conveyance belt 13 indirectly. In a case where the conveyance belt 13 is to be heated, the conveyance belt 13 is heated by infrared ray heater not shown in the drawings, or by a heating wire or film generating Joule heat which is set up inside the pressing roller 18, the driven roller 11, the passive roller 12, or the guide roller 16 via a surface member of those rollers. Similarly, the pressing roller 18 may be heated by Joule heat generated by the electric current added to the heating wire or film set up inside the pressing roller 18.

FIG. 3 shows an exemplary structure of the driven roller 11.

For example, in the driven roller 11 (roller member), an electric heat sheet 112 (heating part, heat source) around the rotation axis 111 disposed on the rotation motor 110 (driver) is arranged cylindrically. The driven roller 11 rotates with the movement of the rotation motor 110. The electric heating sheet 112 is further covered by the cover 113, and the surface of the cover 113 touches the recording medium P. Electric current may pass through the electric heating sheet 112 which generates Joule heat to heat the cover 113. Various elastic materials which generate proper friction with the conveyance belt 13 and which are not deteriorated by heating by the electric heating sheet 112 are used for the cover 113.

The driven rollers to be heated besides the driven roller 11 may have the same structure.

For a roller which is not driven but rotatable with the movement of the conveyance belt 13 such as the passive roller 12, the structure corresponding to the rotation motor 110 is not necessary and the rotating axis has only to be rotatably supported.

The tension roller 19 gives proper tension to the conveyance belt 13 by pressing it from the inner circumferential surface at a position between the conveyance rollers 11 and 12 on the side (other side) where the outer circumferential surface does not face the head units 21, that is, on the track of the conveyance belt 13 moving from the driven roller 11 to the passive roller 12. The position of the tension roller 19 is adjustable up and down in the vertical direction at two positions different in the width direction, on both edges, for example. The tension roller 19 removes windings caused from the unevenness of the tension given to the conveyance belt 13 by the supporting board 14, etc. and enables regular movement of the conveyance belt 13 and the recording medium in the conveyance direction.

As described above, the friction with the conveyance belt 13 increases as the angle ranges of contact with the conveyance belt 13 (wrapping angle β in FIG. 2) in the driven roller 11 and the passive roller 12 are wider. Accordingly, the wrapping angle β is reduced using the tension roller 19 in the range where enough friction is given for the driven roller 11 and the passive roller 12 to certainly move the conveyance belt 13. In that case, the wrapping angle β is determined preferably to be smaller than 180 degrees, more preferably about 120 degrees.

The image recorder 20 includes one or more (four in this embodiment) head units 21 with recording heads ejecting ink. The recording heads are arranged on the side facing the supporting face of the supporting board 14 (recording medium P) of each of the head units 21. The recording heads have a nozzle opening each, and eject ink to land onto the recording medium P conveyed on the supporting face of the supporting board 14 by the conveyance belt 13 according to the movement of the recording heads.

The four head units 21 in this embodiment are respectively connected to the ink tank (not shown in the drawings) of each color, cyan (C), magenta (M), yellow (Y), and black (K), and respectively eject ink of each color of CMYK. On the downstream side in the conveyance direction of the ink landing position on the recording medium P from the head units 21, there may be a configuration for fixing the ink, for example a dryer to dry the dissolvent, an ultraviolet irradiator to solidify the ultraviolet solidification type ink reacted, etc.

The medium discharge unit 40 includes a board-shaped discharge tray 41 on which the recording media P sent out from the conveyor 10 are placed, and stores the recording media P after the image recording until the user takes them out. The discharge tray 41 is configured to be movable in the up and down direction, and may adjust the extent in which the recording media P fall from the height of the supporting face of the conveyor 10 in the proper range.

Between the conveyor 10 and the medium discharge unit 40, there may be a delivery unit with a roller, a belt, etc. to send out the recording medium P safely and securely to the medium discharge unit 40. For example, there may be a belt pulled over the two rollers to lead the recording medium P having passed over the guide roller 17 onto the top of the recording media P in the discharge tray 41.

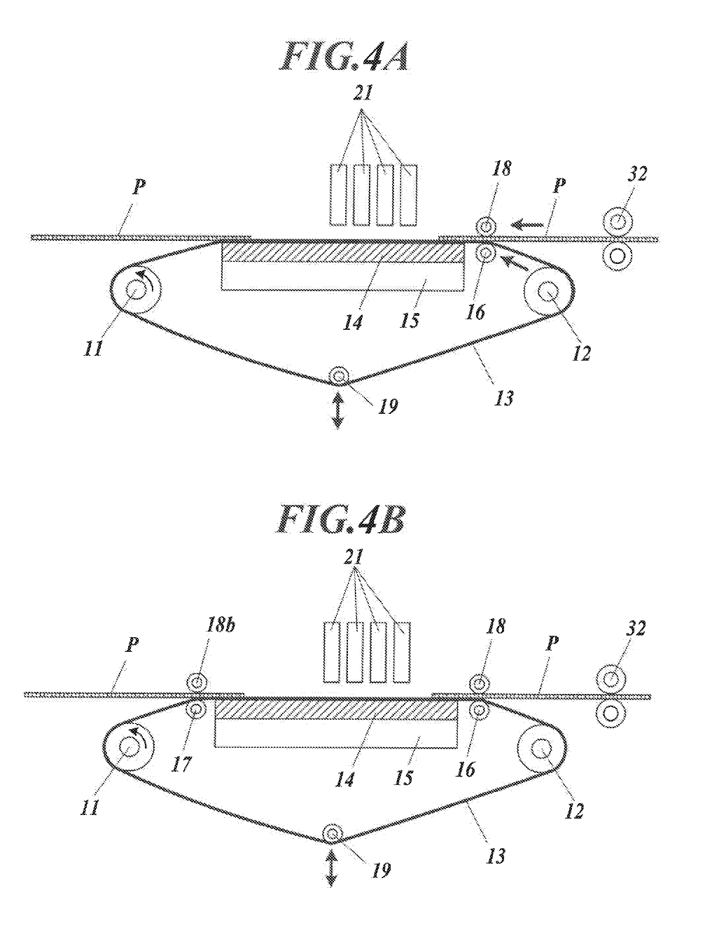

FIGS. 4A and 4B show the modification examples of the conveyor 10 of the inkjet recording device 100 in accordance with the present embodiment.

In the modification example 1 shown in FIG. 4A, the guide roller 16 on the upstream side in the conveyance direction of recording medium P of the supporting board 14 is provided alone and the guide roller 17 is omitted, in the conveyor 10. This causes the conveyance belt 13 to move from the back edge of the supporting face of the supporting board 14 (the edge part on the downstream side in the conveyance direction of the supporting face) to the position touching the conveyance belt 13 in a direction including a vertically downward component. Similarly, the conveyor 10 may have a structure in which the guide roller 17 is provided alone and the guide roller 16 is omitted. In such cases, the stability and positional accuracy of the conveyance belt 13 may be improved with either the guide roller 16 or the guide roller 17 which supports the conveyance belt 13 on the same plane as the supporting face of the supporting board 14 from one side.

In the modification example 2 shown in FIG. 4B, a pressing roller 18b is arranged facing the guide roller 17. As described above, in the regular conveyance operation by the conveyor 10, the pressing roller 18b is arranged on the side where the recording medium P is released from the upper part of the supporting face to hold the recording medium P with the guide roller 17, and in that way the unstableness of the recording medium P which causes the positional deviation or the floating of the terminal (upstream) side edge in the conveyance direction may be prevented, especially in a case where the edge part of the recording medium P is released from the upper part of the supporting face before the image recording on the recording medium P is finished.

That is to say, the operation by the image recorder 20 may be finished effectively with the recording medium P being stably held, in a case where the distance in the conveyance direction from the head unit 21 at the utmost downstream to the downstream side edge of the supporting face is shorter than the length in the conveyance direction of the recording medium P, or in a case where the operation of image reading is performed further by an imaging part such as a line sensor at the section downstream from the head unit 21.

As described hereinbefore, the conveyor 10 which is the recording medium conveyance device of the inkjet recording device 100 in the present embodiment includes the conveyance belt 13 on whose outer circumferential surface the recording medium P is placed, the driven roller 11 and the passive roller 12 over which the conveyance belt 13 is pulled and which causes the conveyance belt 13 to circle according to the rotating movement, the rotation motor 110 which cause the driven roller 11 to rotate, the supporting board 14 (platen) which supports the inner circumferential surface of the conveyance belt 13 on a plane in the one of sections of the conveyance belt 13 divided by the driven roller 11 and the passive roller 12 where the outer circumferential surface faces the ink ejection side of the recording heads of the head units 21, the suction unit 15 which pulls the recording medium P placed on the conveyance belt 13 onto the outer circumferential surface of the conveyance belt 13 by sucking air from the outer circumferential surface side of the conveyance belt 13 through the pores of each of the conveyance belt 13 and the supporting board 14, and the guide roller 16 or 17 which supports the inner circumferential surface of the conveyance belt 13 either between the driven roller 11 and the supporting board 14 or between the passive roller 12 and the supporting board 14 at least. The guide rollers 16 and/or 17 are arranged so that the conveyance belt 13 moves on the same plane as the supporting board 14 between each of the guide rollers 16 and 17 and the supporting board 14.

As described above, the conveyance belt 13 is not pulled directly over between the supporting board 14 and the driven roller 11 and between the supporting board 14 and the passive roller 12. It restrains decrease in the positional accuracy of the recording medium by preventing the shaking of conveyance belt 13, which is mainly caused by sharp bending of the conveyance belt 13 at the driven roller 11 and the passive roller 12, from spreading to the supporting board 14. That is to say, this enables the conveyance of the recording media P with higher positional accuracy in the conveyor 10 of the inkjet recording device 100.

The guide rollers 16 and/or 17 are arranged between the supporting board 14 and the driven roller 11 and/or the passive roller 12. The driven roller 11 and/or the passive roller 12 are arranged so that the conveyance belt 13 moves in the direction crossing the plane at a predetermined angle (that is, the wrapping angle α2≠0) between the driven roller 11 and/or the passive roller 12 and the guide rollers 16 and/or 17.

This stably keeps the placement face at the same height as the supporting face and maintains the positional accuracy with more stable conveyance of the recording medium P. This makes it hard for the recording medium P to touch the conveyance belt 13 between the driven roller 11 and the guide roller 16 and between the passive roller 12 and the guide roller 17 when the recording medium P is supplied and discharged along the supporting face. Thus, the recording medium P and the conveyance belt 13 may be moved more stably.

On the conveyance belt 13, the recording medium P is placed in the section where the conveyance belt 13 moves on the plane of the supporting face of the supporting board 14. That is to say, the recording medium P is not placed on the conveyance belt 13 at the section likely to be unstable such as between the passive roller 12 and the guide roller 16, and the positional accuracy may be improved with more stable conveyance of the recording medium P.

The supporting board 14 is formed with a porous material, and thus air is easily sucked and appropriately to support the conveyance belt 13 on the plane of the supporting face.

The conveyance belt 13 is a steel belt, which enables accurate control over the conveyance speed and position, and which, moreover, effectively restrains shaking between the supporting board 14 and the guide rollers 16 and 17 according to the present invention. Thus, specifically, the decrease in the positional accuracy due to shaking spread to the supporting board 14 may be restrained, and the highly accurate image recording is made possible.

The guide rollers 16 and 17 have smaller rotation radius than the driven roller 11 and the passive roller 12, and the distances between the supporting board 14 and the supporting points of the conveyance belt 13 at the guide rollers 16 and 17 may be reduced even with a simple structure of supporting board 14. Thus, the decrease in the positional accuracy of the recording medium P due to shaking may be restrained in this section.

The pressing roller 18 is arranged on the upstream side from the supporting board 14 in the conveyance direction of the recording medium P by the conveyance belt 13. The pressing roller 18 leads the recording medium P placed on the conveyance belt 13 along the surface of the conveyance belt 13. This prevents the recording medium P from floating, and the recording medium P may be pulled onto the conveyance belt 13 on the supporting face swiftly and securely.

The guide roller 16 is arranged at least on the upstream side from the supporting board 14 in the conveyance direction of recording medium P. The pressing roller 18 is arranged at the position facing the guide roller 16 with the conveyance belt 13 in between. In that way, the pressing roller 18 and the guide roller 16 hold securely the recording medium P in between, prevent it from floating and lead it in the right direction. Moreover, as unnecessary power is not added to the supporting board 14, especially to one made of a porous material, bending and deviation of the supporting board 14 may be prevented.

The guide rollers 16 and 17 are respectively arranged between the driven roller 11 and the supporting board 14 and between the passive roller 12 and the supporting board 14. The pressing rollers 18 and 18b are respectively arranged at the positions facing the guide rollers 16 and 17 with the conveyance belt 13 in between. In that way, the recording medium P is securely held in between when being supplied and discharged, and especially, the recording medium P which is partly caught at the upper part of the supporting board 14 may be more stably held and pulled.

There is provided a tension adjuster which adds tension to the conveyance belt 13 equally at the positions in the width direction perpendicular to the movement direction of the circling conveyance belt 13 in the section opposite to the above-described one section whose outer circumferential surface side faces the head units 21, of the two sections of the conveyance belt 13 divided by the driven roller 11 and the passive roller 12. This makes it possible to remove windings of the conveyance belt 13 possibly caused by the unevenness of tension added by the supporting board 14, and the conveyance belt 13 and the recording media P may move in the accurate conveyance direction.

The electric heating sheet 112 to heat the recording medium P is arranged on the upstream side from the supporting board 14 in the conveyance direction of the recording medium P by the conveyance belt 13. As described above, the electric heating sheet 112 is provided inside the driven roller 11 to heat the driven roller 11, and the conveyance belt 13 touching the driven roller 11 is heated further to heat the recording medium P via the conveyance belt 13, for example. Then, as the recording medium P is adjusted to an appropriate temperature beforehand, ink is landed with equal fixation, coloring, gloss, etc. to record images on the recording medium P with equal and appropriate quality.

The electric heating sheet 112 heats the conveyance belt 13 to heat the recording medium P via the conveyance belt 13, and makes it possible to keep the temperature of the conveyance belt 13 and the recording medium P in the appropriate temperature range and restrain fluctuation of the temperature. Thus, the temperature of the recording medium P is more stably maintained and the quality of recorded images is kept high in the image recording by the inkjet recording device 100.

The electric heating sheet 112 is arranged inside a roller member touching at least either one of the conveyance belt 13 and the recording medium P, and in the present embodiment, inside the driven roller 11. Thus, it is possible to heat the conveyance belt 13 and the recording medium P easily and appropriately without much space being occupied.

The inkjet recording device 100 in the present embodiment includes the conveyor 10 described above, and the head units 21 with recording heads ejecting ink onto the recording media P conveyed by the conveyor 10. The inkjet recording device 100 in the present embodiment enables more stable conveyance of the recording medium P at an accurate position. Thus, the quality of recorded images may be kept high.

The present invention is not limited to the above embodiment, and various changes may be made thereto.

For example, in the above embodiment, it is described that a steel belt is used for the conveyance belt 13. However, the present invention is also applicable to various resin belts, such as a rubber belt.

The supporting board 14 is not limited to a porous material as long as it supports the conveyance belt 13 appropriately on a plane and air can pass through it. A material with artificially processed pores, a mesh-like material, or a combination thereof may be used.

Where the driven roller 11 and the passive roller 12 may remove windings themselves, the tension roller 19 is not necessary. Alternatively, there may be another assistive roller between the driven roller 11 and the passive roller 12. Also, the passive roller 12 may be configured to be driven to rotate cooperatively besides the driven roller 11.

The respective positions of conveyance rollers 11 and 12 are not limited to be arranged such that the conveyance belt 13 between the conveyance rollers 11 and 12 and the guide rollers 16 and 17 crosses the supporting face.

In the above embodiment, the multiple recording media P are sent out one by one from the medium supply unit 30 and conveyed by the conveyor 10. However, the image recorder 20 may record images at predetermined intervals repeatedly on continuous form paper or long fabrics drawn out successively. In that case, a drawing out roll and a take-up roll may be provided instead of the placement tray 31 and the discharge tray 41 respectively in the medium supply unit 30 and the medium discharge unit 40. Alternatively, the medium may not be winded but be cut at the predetermined intervals described above to be discharged.

The pressing roller 18 and the tension roller 19 are not limited to rollers rotatably supported by axis, and simply fixed members, for example, may be used as long as the recording medium P is kept from floating up with its surface not being scratched and as long as the tension of the conveyance belt 13 is adjusted to restrain windings.

There may be multiple tension rollers 19 provided, or alternatively, other assistive rollers (pulley) may be provided between the positions of the driven roller 11 and the passive roller 12.

The pressing rollers 18 and 18b are arranged respectively facing the guide rollers 16 and 17 with the conveyance belt 13 in between, but the positions are not limited thereto. For example, metal frame members fixing both edges of the supporting board 14 may be provided and the pressing rollers 18 and 18b may be configured to be pressed to the frame members to prevent the recording medium P from floating up.

Where the temperature of ink need not be controlled, the conveyor 10 may not include a heater such as the electric heating sheet 112.

In the above embodiment, it is described that the placement face of the recording medium P is horizontal. However, the placement face of the recording medium P may be inclined at any angle, as long as the placement face is kept plane to the inclination of the supporting board 14. As long as the supporting face is formed to be plane, the shape of other surfaces of the supporting board 14 is not limited.

The details of the configurations, structures, and positional relations of each part shown in the above embodiment can be appropriately modified without departing from the scope of the present invention.

### INDUSTRIAL APPLICABILITY

The present invention is applicable to a recording medium conveyance device and an inkjet recording device.

### DESCRIPTION OF REFERENCE NUMERALS

10 Conveyor
11 Driven Roller
110 Rotation Motor
111 Rotation Axis
112 Electric Sheet
113 Cover
12 Passive Roller
13 Conveyance Belt
14 Supporting Board
15 Suction Unit
16, 17 Guide Rollers
18, 18b Pressing Rollers
19 Tension Roller
20 Image Recorder
21 Head Unit
30 Medium Supply Unit
31 Placement Tray
32 Medium Output Unit
40 Medium Discharge Unit
41 Discharge Tray
100 Inkjet Recording Device
P Recording Medium

1. A recording medium conveyance device of an inkjet recording device to record image with a recording head ejecting ink onto a recording medium, the recording medium conveyance device comprising:
an endless belt-form member on an outer circumferential surface of which the recording medium is placed;
two conveyance rollers over which the belt-form member is pulled and which cause the belt-form member to circulate according to a rotation movement;
a driver which causes at least one of the two conveyance rollers to rotate;
a supporting board which supports an inner circumferential surface of the belt-form member on a plane in one section where the outer circumferential surface faces an ink ejection face of the recording head, the one section being one of sections of the belt-form member divided by the two conveyance rollers;
a suction unit which sucks air from a side of the outer circumferential surface of the belt-form member through a pore of the belt-form member and a pore of the supporting board to pull the recording medium placed on the belt-form member to the outer circumferential surface of the belt-form member; and
a guide roller which is arranged between at least one of the two conveyance rollers and the supporting board and which supports the inner circumferential surface of the belt-form member;
wherein the guide roller is arranged such that the belt-form member moves on a plane same as the supporting board between the guide roller and the supporting board.

2. The recording medium conveyance device according to claim 1, wherein the at least one of the conveyance rollers is arranged such that the belt-form member moves in a direction crossing the plane at a predetermined angle between the at least one of the conveyance rollers and the guide roller which is arranged between the at least one of the conveyance rollers and the supporting board.

3. The recording medium conveyance device according to claim 2, wherein the recording medium is placed on the belt-form member in a section where the belt-form member moves on the plane.

4. The recording medium conveyance device according to claim 1, wherein the supporting board is formed using a porous material.

5. The recording medium conveyance device according to claim 1, wherein the belt-form member is a steel belt.

6. The recording medium conveyance device according to claim 1, wherein a rotation radius of the guide roller is smaller than a rotation radius of the at least one of the conveyance rollers.

7. The recording medium conveyance device according to claim 1, wherein a floating suppresser which leads the recording medium placed on the belt-form member along the surface of the belt-form member is arranged on an upstream side from the supporting board in a direction of conveyance of the recording medium by the belt-form member.

8. The recording medium conveyance device according to claim 7,
wherein the guide roller is arranged at least on the upstream side from the supporting board in the direction of conveyance of the recording medium,
wherein the floating suppressor is arranged at a position facing the guide roller with the belt-form member in between.

9. The recording medium conveyance device according to claim 7,
wherein the guide roller is arranged between the supporting board and each of the two conveyance rollers, and
wherein the floating suppressor is each arranged at a position facing the guide roller with the belt-form member in between.

10. The recording medium conveyance device according to claim 1 comprising a tension adjuster which adds tension equally to the belt-form member at positions different in a width direction perpendicular to a movement direction of the circling conveyance belt, in a section opposite to the one section of the sections of the belt-form member divided by the two conveyance rollers.

11. The recording medium conveyance device according to claim 1 comprising a heater which heats the recording medium on the upstream side from the supporting board in a direction of conveyance of the recording medium by the belt-form member.

12. The recording medium conveyance device according to claim 11, wherein the heater heats the recording medium via the belt-form member by heating the belt-form member.

13. The recording medium conveyance device according to claim 11, wherein the heater has a heat source inside at least one roller member touching at least one of the belt-form member and the recording medium.

14. An inkjet recording device comprising a recording medium conveyance device according to claim 1, and the recording head ejecting ink onto the recording medium conveyed by the recording medium conveyance device.
